(19) United States
(12) Patent Application Publication
(10) Pub. No.: US 2018/0039527 A1
(43) Pub. Date: Feb. 8, 2018

(54) Configuring Content Management Systems

(71) Applicant: Veeva Systems Inc., Pleasanton, CA (US)

(72) Inventors: Peter Gassner, Pleasanton, CA (US); Igor Tsives, Shanghai (CN); Jon Stone, Manteca, CA (US); Arvind Talari, Dublin, CA (US)

(73) Assignee: Veeva Systems Inc., Pleasanton, CA (US)

(21) Appl. No.: 15/228,968

(22) Filed: Aug. 4, 2016

(51) Int. Cl. G06F 9/54; G06F 17/30; G06F 9/445

(52) U.S. Cl. CPC G06F 9/543; G06F 9/44505; G06F 17/3007

(57) ABSTRACT

Systems and methods for migrating configuration changes to a target content management system. A migration statement based on a metadata definition language (“MDL”) may be generated with a first API and executed on a source system to generate new source system configurations. A second API may be sent from the source system to the target system and executed on the target system to apply the new source system configurations on the target system without disturbing operation of the target system.

### BACKGROUND

The subject technology relates generally to content management, and more particularly to configuring enterprise content management systems.

Enterprise content management systems are highly configurable. Before starting to use an enterprise content management system, a customer may configure it per its business requirements, or business processes, by creating some customizations on top of out of the box features. The customizations may be, e.g., adding document types or creating custom objects. The customized content management system may be tested in a sandbox environment, and then be cloned into a production environment. When new business requirements come in, the customer needs to determine how to change the configuration of the existing content management system to satisfy the new business requirements, and implement new configurations on top of the existing content management system without interrupting operation of the actual production system.

### SUMMARY

The disclosed subject matter relates to a method for migrating configuration changes to a target content management system. The method comprises: exposing a first application programming interface (“API”); and generating a first migration statement with the first API, wherein the first migration statement comprises information about existing configuration of a source system, a first migration command, type of a first source system component, and name of the first source system component. The method further comprises: executing the first migration statement on the source system to generate new source system configurations; and sending a second API from the source system to the target system, wherein the second API contains new source system configurations as an input. The method further comprises: executing the second API on the target system to apply the new source system configurations on the target system without disturbing operation of the target system.

### BRIEF DESCRIPTION OF THE DRAWINGS

FIG. 1A illustrates an example high level block diagram of an enterprise content management architecture wherein the present invention may be implemented.

FIG. 1B illustrates an example high level block diagram of an enterprise content management architecture wherein the present invention may be implemented.

FIG. 2 illustrates an example high level block diagram of a computing device.

FIG. 3 illustrates an example high level block diagram of the content management server according to one embodiment of the present invention.

FIG. 4 illustrates an example flowchart of a method for migrating configuration changes in a content management system according to one embodiment of the present invention.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

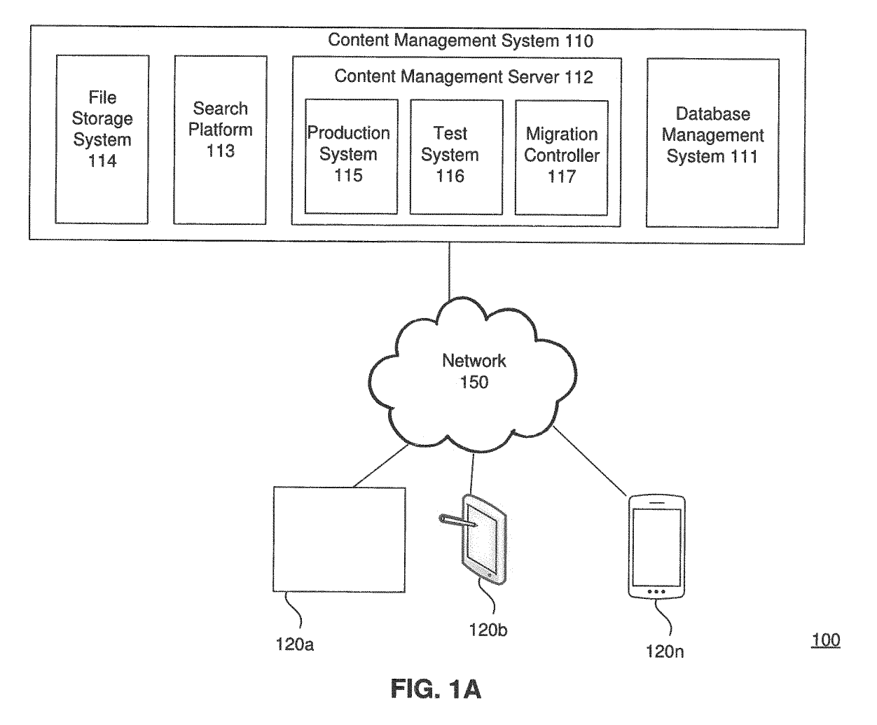

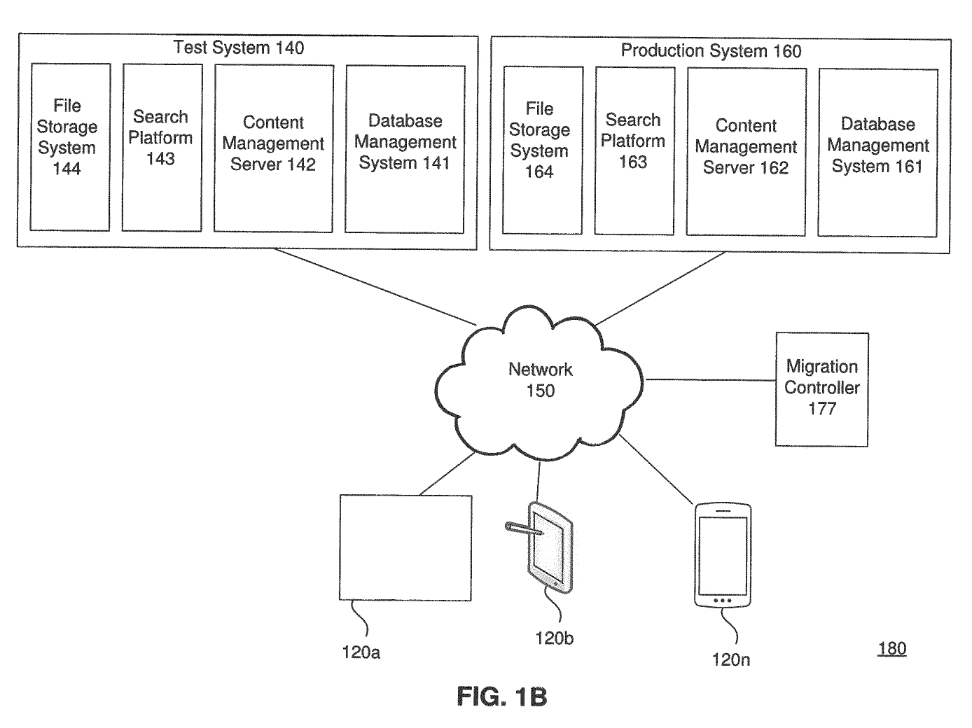

FIG. 1 illustrates an example high level block diagram of an enterprise content management architecture 100 wherein the present invention may be implemented. The enterprise may be a business, or an organization. As shown, the architecture 100 may include a content management system 110, and a plurality of user computing devices 120a, 120b, . . . 120n, coupled to each other via a network 150. The content management system 110 may store content that user computing devices 120a-120n may access and allow users to interact with its content in a specific business context. The content management system 110 may include a database management system 111, a content management server 112, a search platform 113 and a file storage system 114. The network 150 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

The user computing devices 120a-120n may be any machine or system that is used by a user to access the content management system 110 via the network 150, and may be any commercially available computing devices including laptop computers, desktop computers, mobile phones, smart phones, tablet computers, netbooks, and personal digital assistants (PDAs).

The content management server 112 is typically a remote computer system accessible over a remote or local network, such as the network 150. Various code in the content management server 112 may commit data (e.g., customer data) to the search platform 113 to make the data visible to users of the content management system 110. The content management server 112 may have a production system 115 for running the actual existing content management configurations, a test system 116 for testing new content management configurations, and/or a configuration migration controller 117 for controlling the configuration migration from the test system 116 to the production system 115. The configurations are metadata and may comprise one or more applications. It should be appreciated that the production system 115, the test system 116 and the migration controller 117 may be in separate servers. A user may test and validate new configurations in the test system 116, and the migration controller 117 may control migration of the new configurations from the test system 116 to the production system 115.

The database management system 111 may be a relational database management system, and may store data and metadata of documents and/or objects in the file storage system 114. Data may be taken out of the database management system 111, processed and sent to a denormalized dataset store (e.g., the search platform 113) to make it easier to search and retrieve. Consequently, the content management server 112 may interact with the persistent data, which is a combination of the database management system 111 and the search platform 113. In one implementation, the database management system 111 may be a MySQL system.

The file storage system 114 may store documents and/or objects.

In one implementation, the content management system 110 may be a multi-tenant system where various elements of hardware and software may be shared by one or more customers. For instance, a server may simultaneously process requests from a plurality of customers, and the content management system 110 may store content for a plurality of customers. In a multi-tenant system, a user is typically associated with a particular customer. In one example, a user could be an employee of one of a number of pharmaceutical companies which are tenants, or customers, of the content management system 110.

In one embodiment, the content management system 110 may run on a cloud computing platform. Users can access content on the cloud independently by using a virtual machine image, or purchasing access to a service maintained by a cloud database provider.

In one embodiment, the content management system 110 may be provided as Software as a Service (“SaaS”) to allow users to access the content management system 110 with a thin client.

FIG. 1B illustrates an example high level block diagram of another enterprise content management architecture wherein the present invention may be implemented. As shown, the architecture 180 may include a test system 140, a production system 160, a migration controller 177, and a plurality of user computing devices 120a, 120b, . . . 120n, coupled to each other via a network 150. The production system 160 may store content that user computing devices 120a-120n may access and allow users to interact with its content in a specific business context. The test system 140 may include a database management system 141, a content management server 142, a search platform 143 and a file storage system 144. The production system 160 may include a database management system 161, a content management server 162, a search platform 163 and a file storage system 164. A user may test and validate new configurations in the test system 140, and the migration controller 177 may control migration of the new configurations from the test system 140 to the production system 160.

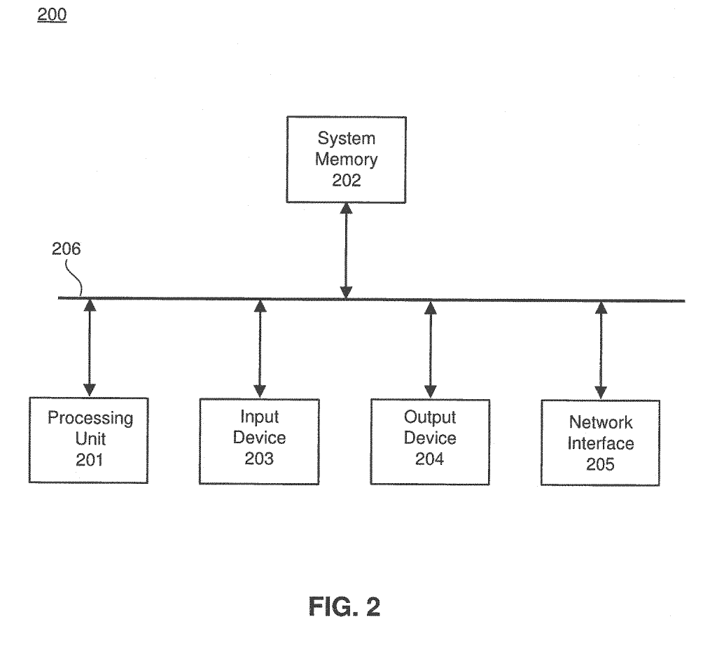

FIG. 2 illustrates an example block diagram of a computing device 200 which can be used as the user computing devices 120a-120n, and/or the content management server 112 in FIGS. 1A and 1B. The computing device 200 is only one example of a suitable computing environment and is not intended to suggest any limitation as to scope of use or functionality. The computing device 200 may include a processing unit 201, a system memory 202, an input device 203, an output device 204, a network interface 205 and a system bus 206 that couples these components to each other.

The processing unit 201 may be configured to execute computer instructions that are stored in a computer-readable medium, for example, the system memory 202. The processing unit 201 may be a central processing unit (CPU).

The system memory 202 typically includes a variety of computer readable media which may be any available media accessible by the processing unit 201. For instance, the system memory 202 may include computer storage media in the form of volatile and/or nonvolatile memory such as read only memory (ROM) and/or random access memory (RAM). By way of example, but not limitation, the system memory 202 may store instructions and data, e.g., an operating system, program modules, various application programs, and program data.

A user can enter commands and information to the computing device 200 through the input device 203. The input device 203 may be, e.g., a keyboard, a touchscreen input device, a touch pad, a mouse, a microphone, and/or a pen.

The computing device 200 may provide its output via the output device 204 which may be, e.g., a monitor or other type of display device, a speaker, or a printer.

The computing device 200, through the network interface 205, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 150) and/or buses. The network interface 205 may be configured to allow the computing device 200 to transmit and receive data in a network, for example, the network 150. The network interface 205 may include one or more network interface cards (NICs).

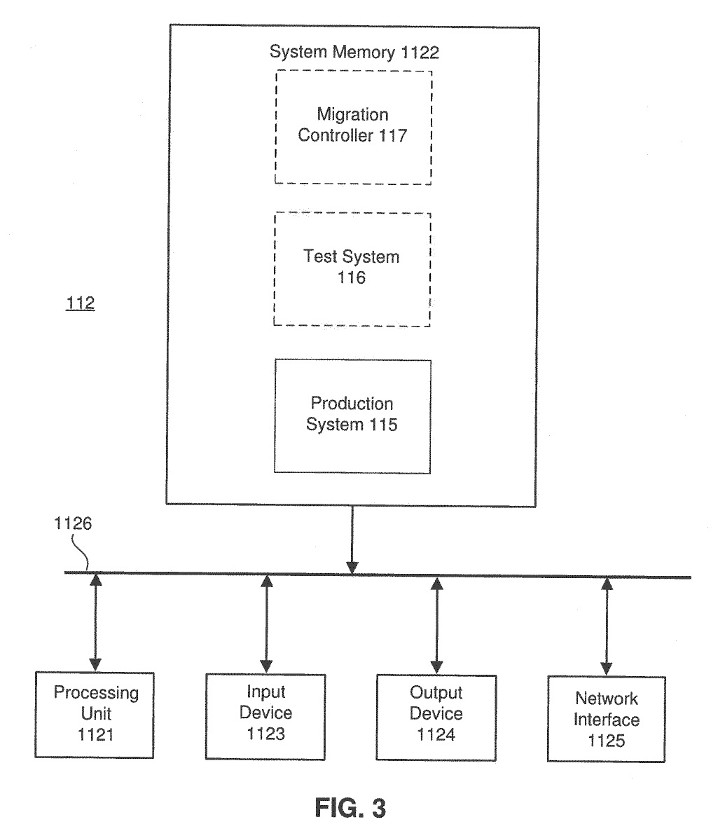

FIG. 3 illustrates an example high level block diagram of the content management server 112 according to one embodiment of the present invention. The content management server 112 may be implemented by the computing device 200, and may have a processing unit 1121, a system memory 1122, an input device 1123, an output device 1124, and a network interface 1125, coupled to each other via a system bus 1126. The system memory 1123 may store the production system 115, the test system 116 and/or the migration controller 117.

The present invention uses a metadata definition language (“MDL”) to configure content management systems without disturbing operation of the content management system. Main functions of the MDL may include: providing a list of MDL enabled components, with each of the components the MDL functions described below can be invoked; describing an MDL component; define the metadata for each MDL component; exporting an MDL component by retrieving its definition; and importing configuration of one or more components by manipulating their definitions.

MDL components define the model that holds the data for content management system configurations. Each component may contain a set of attributes and optionally further sub-components. The attributes define the data type and validation rules which are enforced when values are set into the attributes. The present invention provides a component metadata framework with which the components could get annotated and the shape and validation rules of the components could be dynamically acquired by client applications and an MDL parser. In one implementation, the component metadata framework may define the metadata for each component consisting of the following:

TABLE 1

| Metadata Field | Description |
|---|---|
| name | Component type name |
| label | Component user friendly label |
| active | Component status (true/false) |

The framework defines the metadata for each of the component attributes consisting of the following:

TABLE 2

| Metadata Field | Type | Description |
|---|---|---|
| name | String | The unique attribute identifier |
| type | enum | the type of the data that can be stored by the |
| | | attribute, options: String, Number, Boolean, |
| | | Date, DateTime, XMLString, JSONString, |
| | | <MDL Component>, |
| requiredness | enum | Whether it is required, optional or conditionally |
| | | required to provide the value in this attribute. |
| | | Options: “required”, “optional’, “conditional” |
| max_length | Number | Maximum length of the String (for String |
| | | attributes) |
| max_value | Number | Maximum number that can be set into the |
| | | attribute (value can be float) |
| min_value | Number | Minimum number that can be set into the |
| | | attribute (value can be float) |
| editable | Boolean | Whether it is allowed to update the value in this |
| | | attribute |
| multi_value | Boolean | Whether multiple values can he set |
| ordered | Boolean | For multi-value attributes, whether values in |
| | | the list are ordered |
| enums | List | A defined list of acceptable values for an |
| | | attribute. |

The framework may define the metadata for each component's sub-components consisting of the following:

TABLE 3

| Metadata Field | Description |
|---|---|
| name | Component type name |
| label | Component type label |

Table 4 shows an example of an MDL component, Doctype.

TABLE 4
Component Doctype

| Attribute | Definition | Description |
|---|---|---|
| name* | [required], | Component's name. It is not part of the MDL |
| | string | attribute list, but is returned on Describe |
| label | [required], | UI-friendly string |
| | string | |
| active | [required], | options: true/false |
| | boolean | |
| document_number_format | [optional], | the document numbering pattern. if none are |
| | string | specified the default value is inherited from |
| | | parent or base |
| document_name_format | [optional], | the document numbering pattern. if none are |
| | string | specified the default value is inherited from |
| | | parent or base |
| | | If not specified at root, the default is: |
| | | {FileName} |
| available_lifecycles | [optional] list | the list of Lifecycle names. if none are |
| | | specified the default value is inherited from |
| | | parent or base |
| rendition_types | [optional] list | the list of rendition type names |
| relationship_types | [optional] list | the list of relationship type names |
| create_document_permissions | [optional] list - | the list of group or user IDs in the form of |
| | users and/or | user:username or Group.name_v |
| | groups | |
| create_binder_permissions | [optional] list - | the list of group or user IDs in the form of |
| | users and/or | user:username or Group.name_v |
| | groups | |
| role_defaulting_editors | [optional] list - | the list of group or user IDs in the form of |
| | users and/or | user:username or Group.name_v |
| | groups | |
| role_defaulting_viewers | [optional] list - | the list of group or user IDs in the form of |
| | users and/or | user:username or Group.name_v |
| | groups | |
| role_defaulting_consumers | [optional] list - | the list of group or user IDs in the form of |
| | users and/or | user:username or Group.name_v |
| | groups | |
| processes ** | [optional] list | the list of process names. these come from |
| | | processes picklist |
| etmf_department ** | [optional] | the department name from etmf_departmnet |
| | enum | picklist |
| default_workflows ** | [optional] list | the list consists of lifecycle/workflow |
| | | combinations separated by ‘:’ char.. e.g. |
| | | “promotional_field_c:start_mld_review_c” |
| filters | [required] list | names of fields for document fields using |
| | of fields | MDL notation: Docfield.field_v |
| | | additional special filters: date_search, |
| | | user_search, version_search. |
| | | file_format_search |
| fields | [optional] list | the list of Docfield components linked to this |
| | | Doctype |

A “describe” endpoint may allow retrieval of the JSON/XML representation of individual Document Types, or the entire Document type hierarchy.

The content management configuration may include other components, e.g., Document Attributes, Lifecycle, Workflows and Objects.

Below is an example of component metadata for the Docfield component type:

```
{
  ″responseStatus″: ″SUCCESS″,
  ″data″:
  {
    ″name″: ″Docfield″,
  ″label″: ″Document Field″,
  ″active″: true,
  ″attributes″: [
  {
    ″name″: ″label″,
    ″label″: ″Label″,
    ″type″: ″String″,
    ″requiredness″: ″required″,
    ″max length″: 255,
    ″editable″: true
  },
  {
    ″name″: ″active″,
    ″label″: ″Active″,
    ″type″: ″Boolean″,
    ″requiredness″: ″required″,
    ″editable″: true
  }],
  ″sub_components″: [
  {
    ″name″: ″Picklistentry″,
    ″label″: ″Picklist Entry″,
    ″attributes″: [
      {
        ″name″: ″label″,
        ″label″: ″Label″,
        ″type″: ″String″,
        ″requiredness″: ″required″,
        ″max_length″: 255,
        ″editable″: true
      },
      {
        ″name″: ″active″,
        ″label″: ″Active″,
        ″type″: ″Boolean″,
        ″requiredness″: ″required″,
      }
    }],
    }
}
```

MDL uses a number of application programing interfaces (“APIs”) as tools. One API may have a Describe function for generating information about the existing configuration in order for the API to generate or create a command. One example API may allow the user to describe a component in JSON or XML format for run time applications. One example Execute API may allow the user to execute a command or a set of commands grouped together into a script. Other APIs may include a Component Shape API, an Error API, and a directory of component API.

MDL provides a number of commands, including RECREATE, CREATE, ALTER, DROP, RENAME, or COMMIT, as will be discussed in detail below.

RECREATE is a command to recreate a source system (e.g., the test system 140) component on the target system (e.g., the production system 160). When there is a description of a source system component and the same component has been deployed to the target system, and the source system makes some modifications to the source system component (e.g., adding a couple of new fields, removing a couple of existing fields, and changing the configuration of one of the existing fields), the RECREATE command may be created and applied to make sure that the target system looks exactly the same as the source system after the migration. In one implementation, the RECREATE statement syntax is as follows:

```
RECREATE Componenttype name_{namespace suffux} (
      component_definition,...
      [sub_component_definition,...]
);
component_definition:
      attribute_name(attribute_value)
sub_component _definition:
      Componenttype name_{namespace suffix} (
        Component_definition,...
    )
                                            (1)
```

RECREATE Componenttype may either create a new component instance or alter an existing component instance (identified by the name) such that the final component instance contains the exact data as specified in the RECREATE command.

The attribute_value is represented depending on the datatype it stores. For example, the number values are represented as attribute_name(37):

Supported Data Type for Attribute Values:

String: (‘string value’)

Number: (37)

Boolean: (true)

List/Array: (‘elem1’, ‘elem2’)

Component Reference: (Object.product_v)

Below is an example syntax for a basis component RECREATE:

```
RECREATE Docfield country_v (
label('Country'),
  active(true),
  type('ObjectReference'),
  object(′Object.country_v'),
  required(false),
  shared(true),
  multi_value(true),
  display_section('Docfieldlayout.general_vs'),
  default_value( ).
  blank_fields( ),
  controlling_field( ),
  max_value( ),
  min_value( )
  max_length( ),
scale( ),
  help_content( ),
  default _security('editable'),
  security_override_editable( ),
  security_ override_readonly( ),
  security_override_hidden( ),
  defined _ in( ),
  picklist ( )
);
```

CREATE is a command to create a new component on the target system. In one implementation, the CREATE statement syntax is as follows:

```
CREATE Componenttype name_{namespace suffux} (
  component_definition,...
  [sub_component_definition,...]
);
component_definition:
  attribute_name(atribute_value)
sub_component _definition:
  Componenttype name_{namespace suffix} (
    Component_definition,...
  )
                                            (2)
```

CREATE Componenttype may create a new component instance. If the component with indicated name already exists, an error is returned.

The attribute value is represented depending on the datatype it stores. For example, the number values are represented as attribute_name(37)

Supported Data Type for Attribute Values:

String: (‘string value’)

Number: (37)

Boolean: (true)

List/Array: (‘elem1’, ‘elem2’)

Component Reference: (Object.product_v)

Below is an example syntax for a basis component CREATE:

CREATE Docfield my_country_v (
label('My Country'),
active(true),
type('ObjectReferenee'),
object(′Object.country_v'),
required(false),
shared(true),
multi_value(true),
display_section('Docfieldlayout.general_vs'),
default_value( ).
blank_fields( ),
controlling_field( ),
max_value( ),
min_value( )
max_length( ),
scale( ),
help_content( ),
default _security('editable'),
security_override_editable( ),
security_ override_readonly( ),
security_override_hidden( ),
defined _ in( ),
picklist( )
);

ALTER is a command to alter an existing component (e.g., adding a new field, changing the configuration of an existing field, or changing the label). In one example, when the command is to change a label from application row to something else, the command may say “Alter application row name.” The command may update the metadata on the target system to change the label of a particular component. In one implementation, the ALTER statement syntax is as follows:

```
ALTER Componenttype name_{namespace suffix} (
[alter_specification [, alter_specification ] ...]
);
alter_specification:
  [ component_definition [, component_definition ] ... ]
  | ADD Componenttype name_{namespace suffix} (
      component_definition
    )
  | MODIFY Componenttype name_{namespace suffix] (
      component_definition
    )
  | DROP Componenttype name_ {namespace suffix}
                                            (3)
```

ALTER Componenttype may update the component instance by changing attribute values at the component or sub-component level, or by adding, modifying or dropping sub-components.

Below is an example syntax for component ALTER:

```
ALTER Object my_product_c (
  label('New Label'),
  MODIFY Field my_field_c (
    label('New Label')
  ),
  DROP Field old__field_c,
  ADD Field new_field_c (
  label(Field Name'),
    type('String'),
    active(true),
    required(true),
    unique(true),
    max_length(128),
    help_content( ),
    list_column(true),
    order(1),
    system_managed_name(false),
    start_number( ),
    value_format( ),
    lookup_relationship_name( ),
    lookup_source_field( )
        )
      );
```

It may be possible to ADD or DROP one or more values from a multi-value attribute:

```
ALTER Job effective_periodic_review_c (
  job_actions DROP ('my_upcoming_effectivity_job_action_c'),
)
ALTER Job effective_periodic_review_c (
  job_actions ADD ('my_ job_c','my_upcoming_effectivity_job_action_c'),
)
```

ALTER may also support ADD FIRST and ADD AFTER attribute syntax. This may allow ALTER to control the position of the value inside a multi-value attribute. A specific example is an ordinal position of the field inside a section. For example:

```
ALTER Docfieldlayout general_section_c (
  fields('Docfield.field3_v','Docfield.field5_v')
);
To insert field(s) into the list starting at the position 1:
ALTER Docfieldlayout general_section_c (
  fields ADD ('Docfield.field1_v','Docfield.field2._ v') FIRST
);
To insert field(s) after Docfield.field3_v:
ALTER Docfieldlayout general_section_c (
  fields ADD ('Docfield.field4_v') AFTER ('Docfield.field3_v')
);
```

By default, ADD may insert the value(s) at the last position of the list:

ALTER Docfieldlayout general_section_c (
fields ADD ('Docfield.field6_v')
);

DROP is a command to delete a component. In one implementation, the DROP statement syntax is as follows:

DROP Componenttype name_{namespace suffix};
DROP Componenttype deletes a component instance identified by its name.
(4)

An example of the DROP command is as follows:

DROP Object my_product_c;

RENAME is a command to rename a component. In one implementation, the RENAME statement syntax is as follows:

RENAME Componenttype name_{old namespace suffix} TO name_{new
namespace suffix};
(5)

RENAME Componenttype may rename the component instance from one name to another.

START TRANSACTION/COMMIT are commands to commit the changes to the target system.

```
START TRANSACTION;
  [ mdl_statement [, mdl_statement] ... ]
COMMIT;
                              (6)
```

The START TRANSACTION/COMMIT commands may allow executing several migration statements in a transaction.

The user may put in as many detailed statements as he wants, and each one may accomplish a task, e.g., DROP, RENAME, or CREATE. The user may fill out this very elaborate script very quickly, and modify the entire configuration of the target system in one execution. For example, a user wants to:
re-label the navmenu itself;
re-label library_v subcomponent;
delete product_info_c menu item and all sub-items; and
add product_category_vs menu item.

The migration statement may be:

```
ALTER Navmenu navmenu_v (
  label('New Label'),
  MODIFY Navmenuitem library_v (
    label('My Library'),
  ),
  DROP Navmenuitem product_info_c,
ADD Navmenuitem product_category_vs (
    label('Product Category'),
type('container'),
    order(3)
  )
);
```

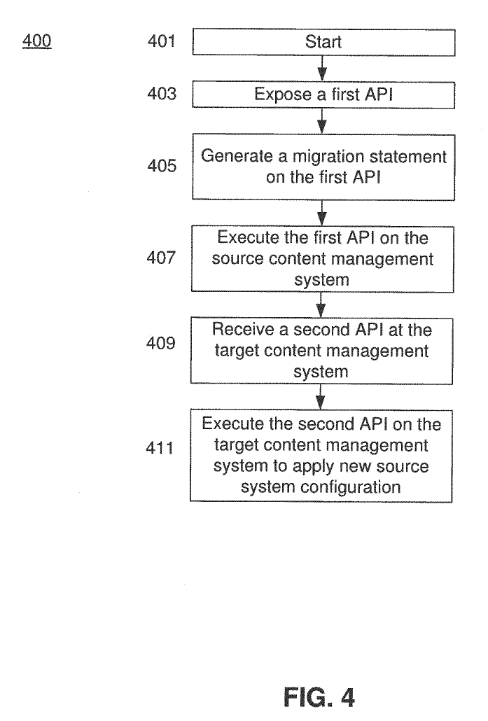

FIG. 4 illustrates an example flowchart of a method for migrating configuration changes in a content management system according to one embodiment of the present invention. The customer may have configured a content management system per its business requirements in the production system 160 in FIG. 1B. To satisfy new business requirements, the customer needs to change configurations of the production system 160, and has implemented new configurations on top of the existing production system 160 in the test system 140, and tested and validated the new configurations in the test system 140. The customer now needs to migrate the new configurations from the test system 140 to the production system 160. The process may start at 401.

At 403, a first application programming interface (“API”) may be exposed by the migration controller 177 for a user to create a migration statement. One example API may allow the user to create a command, and apply it to a source system (e.g., the test system 140).

At 405, a migration statement may be generated with the first API. The migration statement may have a command (e.g., RECREATE, CREATE, ALTER, DROP, RENAME, or COMMIT), component type, component name, and body of the statement of what the user is trying to do.

At 407, the migration statement may be executed on the source system to generate new source system configurations.

At 409, a second API, which contains new source system configurations as an input, may be sent from the source system to the target system.

At 411, the second API may be executed on the target system to apply the new source system configurations to the target system without disturbing normal operation of the target system.

The present invention may provide a robust error framework in the execution part. When it executes a migration statement, it may analyze what the user is trying to do, e.g., recreating a particular component. If there is an error, the error framework may generate an error code to indicate where the error occurred, the line number, the component that generates the error, the operation that generates the error, and what was trying to do when that error occurred. Based on the error code, the user may determine if there is a warning or failure. The error code may also indicate the reason type, the actual cause, and the classification of error, e.g., permission denied, invalid input, or parameter that was not supplied. When the user is executing a script consisting of mini commands, the error code may indicate which particular command within the script that causes the error.

With the migration statements, the user may define transactional boundaries. For example, if the user wants two components to execute, and wants to insure that both of them are executed successfully, the user may put them into a transactional boundary, so that if at least one of them fails, the whole thing fails, like all or none.

With the migration statements, users may build components in a very consistent way. Components, by default, become migratable. With this set of APIs, users can create migration scripts that will exercise the commands, to extract configuration, and deploy configuration into the target system. In one implementation, old components may become migratable if they are enabled retroactively.

With the migration statements, user may describe the configuration, and then deploy the configuration to the target system. The configuration is metadata, and the commands operate on the metadata level. In one implementation, one script may be sent to multiple target systems to deploy configuration.

Although the embodiments are described with migrating configuration changes from the test system to the production system in a content management system, the present invention may be used in other situations. In one implementation, the migration statements may be used to migrate configuration changes between two content management systems. In one implementation, the migration statements may be used as an application deployer, not just a single configuration deployer, by configuring the target system to enable a new set of features. Users may create their own application package by putting some migration commands together, which may create metadata configuration for that application.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

What is claimed is:

1. A method for migrating configuration changes from a source system to a target content management system, comprising:
exposing a first application programming interface (“API”);
generating a first migration statement with the first API, wherein the first migration statement comprises information about existing configuration of the source system, a first migration command, type of a first source system component, and name of the first source system component;
executing the first migration statement on the source system to generate new source system configurations;
sending a second API from the source system to the target system, wherein the second API contains new source system configurations as an input; and
executing the second API on the target system to apply the new source system configurations on the target system to migrate configuration changes from the source system to the target system without disturbing operation of the target system.

2. The method of claim 1, wherein the source system is a test content management system.

3. The method of claim 1, wherein the first migration command is for recreating the first source system component on the target system.

4. The method of claim 1, wherein the first migration command is for creating a new component on the target system.

5. The method of claim 1, wherein the first migration statement is for altering a component on the target system.

6. The method of claim 1, wherein the first migration statement is for dropping a component on the target system.

7. The method of claim 1, wherein the first migration statement is for renaming a component on the target system.

8. The method of claim 1, wherein the first migration statement is for committing configuration changes to the target system.

9. The method of claim 1, wherein the configuration changes are at metadata level.

10. The method of claim 1, wherein the first migration statement is based on a metadata definition language (“MDL”).

11. The method of claim 1, wherein the first source system component is MDL enabled.

12. The method of claim 1, further comprising: providing a list of MDL enabled components, and executing the first migration statement on the MDL enabled components.

13. The method of claim 12, further comprising: describing an MDL enabled component.

14. The method of claim 12, further comprising: exporting an MDL enabled component by retrieving its definition; and importing configuration of one or more MDL enabled components by manipulating their definitions.

15. A content management system, comprising:
a source system which comprises: a first content management server, a first file storage system for storing documents and objects, and a first database management system for storing data and metadata of the documents and objects in the first file storage system; and
a migration controller for migrating configuration changes from the source system to a target content management system, wherein the migration controller:
exposes a first application programming interface (“API”);
enables generation of a first migration statement with the first API, wherein the first migration statement comprises information about existing configuration of the source system, a first migration command, type of a first source system component, and name of the first source system component;
enables execution of the first migration statement on the source system to generate new source system configurations; and
sends a second API from the source system to a target system, wherein the second API contains new source system configurations as an input; and wherein the second API is executed on the target system to apply the new source system configurations on the target system to migrate configuration changes from the source system to the target system without disturbing operation of the target system.

16. The system of claim 15, wherein the source system is a test content management system.

17. The system of claim 15, wherein the first migration command is for recreating the first source system component on the target system.

18. The system of claim 15, wherein the first migration command is for creating a new component on the target system.

19. The system of claim 15, wherein the first migration statement is for altering a component on the target system.

20. The system of claim 15, wherein the first migration statement is for dropping a component on the target system.
